(19) United States
(12) Patent Application Publication
(10) Pub. No.: US 2005/0226613 A1
(43) Pub. Date: Oct. 13, 2005

(54) Net chromatic dispersion measurement and compensation method and system for optical networks

(76) Inventor: Lutz Raddatz, Plauen (DE)

Correspondence Address: MOSER, PATTERSON & SHERIDAN, LLP/;LUCENT TECHNOLOGIES, INC, 595 SHREWSBURY AVENUE, SHREWSBURY, NJ, 07702, US

(21) Appl. No.: 10/813,154

(22) Filed: Mar. 30, 2004

(51) Int. Cl. H04B 10/08

(52) U.S. Cl. 398/27

(57) ABSTRACT

Residual chromatic dispersion in an optical transmission system is measured and compensated by utilizing the bit error rate for the system. A predetermined amount of chromatic dispersion is introduced into receive end of the optical transmission system and the bit error rate is measured and associated with that predetermined amount of chromatic dispersion. The predetermined amount of chromatic dispersion is then changed to a new predetermined amount to reduce and, ultimately, minimize the bit error rate. Total residual chromatic dispersion is then measured as the complement of the predetermined amount of chromatic dispersion that corresponds to the minimum bit error rate. At least some portion of the residual chromatic dispersion is compensated by introducing a fixed amount of dispersion in a range from 0 ps/nm to and including the predetermined amount of chromatic dispersion that corresponds to the minimum bit error rate. In one exemplary embodiment, selection of the predetermined amount of chromatic dispersion is adaptively controlled to reduce the measured bit error rate.

### FIELD OF THE INVENTION

This invention relates to the field of optical networks and, more specifically, to a system and method adapted for measuring and compensating net chromatic dispersion in the optical network.

### BACKGROUND OF THE INVENTION

Chromatic dispersion is an important parameter in optical transmission systems. It affects system performance particularly in high speed, long distance systems where the bit rate is greater than or equal to 10 Gbps and the distance exceeds 1,000 km. As a result, it has become necessary to develop dispersion characterizations for most, if not all, components in the optical transmission system from the individual fiber spans to the optical amplifiers. After the system is characterized, it is possible to manage the chromatic dispersion measured and characterized above by using dispersion compensation modules throughout the system.

Chromatic dispersion management is not a perfect process that is immune from error and the need for recalibration. For example, as new elements are added to the system, the chromatic dispersion will be become uncompensated, at least in part. Uncharacterized components such as lengths of splice fibers, connection fibers to patch panels and the like can add to the dispersion of an installed system and yet remain uncompensated. Measurement errors for the hundreds or thousands of components of a complete, long haul optical transmission system can accumulate into a meaningful amount of dispersion. Finally, installation errors can cause incorrect chromatic dispersion amounts to be compensated in the system. In all these cases, there arises a residual amount of chromatic dispersion that is uncompensated and that affects overall system performance.

When the optical transmission system is operational, additional dispersion changes occur in response to environmental changes affecting the ambient temperature of the fiber, for example. Well designed systems generally anticipate such changes by insuring that they are within the range of the receiver.

### SUMMARY OF THE INVENTION

Residual chromatic dispersion in an optical transmission system is measured and compensated in accordance with the principles of the invention by utilizing the bit error rate for the system. A predetermined amount of chromatic dispersion is introduced into receive end of the optical transmission system and the bit error rate is measured and associated with that predetermined amount of chromatic dispersion. The predetermined amount of chromatic dispersion is then changed to a new predetermined amount to reduce and, ultimately, minimize the bit error rate. Total residual chromatic dispersion is then measured as the complement of the predetermined amount of chromatic dispersion that corresponds to the minimum bit error rate.

In one exemplary embodiment of the invention, at least some portion of the residual chromatic dispersion is compensated by introducing a fixed amount of dispersion in a range from 0 ps/nm to and including the predetermined amount of chromatic dispersion that corresponds to the minimum bit error rate.

In another embodiment of the invention, selection of the predetermined amount of chromatic dispersion is adaptively controlled to reduce the measured bit error rate.

Apparatus and method embodiments are presented in the description and claims that follow.

### BRIEF DESCRIPTION OF THE DRAWINGS

A more complete understanding of the invention may be obtained by reading the following description of specific illustrative embodiments of the invention in conjunction with the appended drawings in which:

FIG. 1 shows a block diagram of an optical transmission system including apparatus for measuring and compensating residual chromatic dispersion in accordance with the principles of the present invention; and

FIG. 2 shows a graph of dispersion versus bit error rate.

### DETAILED DESCRIPTION OF THE INVENTION

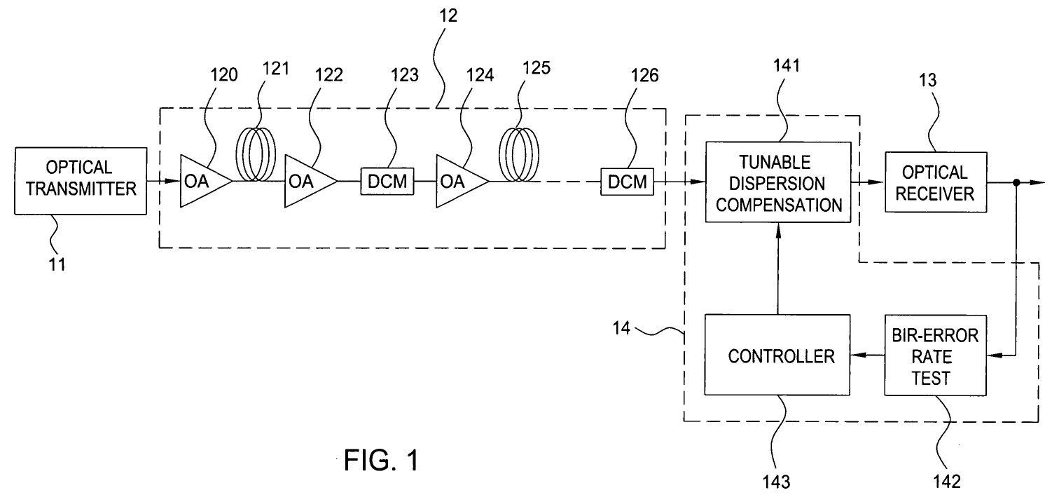

FIG. 1 shows an optical transmission system including a module for measuring and compensating residual chromatic dispersion in accordance with the principles of the invention. The optical transmission system includes optical transmitter 11, transmission system 12, and optical receiver 13 coupled together as shown. Module 14 is inserted into the system between transmission system 12 and receiver 13. An output from optical receiver 13 is coupled into an input port of module 14. Module 14 performs residual chromatic dispersion measurement and compensation in accordance with the principles of the invention.

Transmission system 12 is shown in an exemplary manner including a combination of optical amplifiers, optical fiber spans, and dispersion compensation modules. The optical amplifiers are shown as elements 120, 122, and 124. The optical fiber spans are shown as elements 121 and 125. The dispersion compensation modules are shown as elements 123, and 126. One illustrative section of the transmission system 12 includes optical amplifier 120 coupled to optical fiber span 121 which, in turn, is coupled to optical amplifier 122 which, in turn, is coupled to dispersion compensation module 123. Multiple sections can be concatenated to form the entire long haul transmission system.

Dispersion compensation modules 123 and 126, among others (not shown) distributed within transmission system 12, are used to compensate the chromatic dispersion characterized for the various components of the system. As described above, however, these dispersion compensation modules do not compensate or effectively eliminate the chromatic dispersion within the system. There is still some uncompensated chromatic dispersion known as residual or net chromatic dispersion. It is the latter dispersion that module 14 is designed to measure in accordance with the principles of the invention. Dispersion compensation is also contemplated within the scope of the present invention.

Module 14 includes tunable dispersion compensator 141, bit error rate test (BERT) element 142, and controller 143. Module 14 is inserted into the optical transmission system at its receive end to receive optical signals transmitted across system 12 as well as the signals output from receiver 13.

Tunable dispersion compensator 141 provides a predetermined amount of dispersion into the optical transmission path prior to the optical receiver 13. The predetermined amount of dispersion can be adjusted across a broad range of dispersion amounts. Manual and automatic or adaptive adjustment capabilities are anticipated for use in tunable dispersion compensator 141. Tunable dispersion compensators are well known in the art.

BERT element 142 measures the bit error rate for optical signals propagating across transmission system 12 and recovered by receiver 13. BERT element 142 responds to the signals recovered by receiver 13 to analyze those signals for the occurrence of bit errors and then to generate a signal representative of the bit error rate for the system. These elements are well known and widely available in the art. In general, BERT element 142 responds to a known bit pattern in the signals recovered by optical receiver 13. The pattern can be a pre-established pattern of bits such as a pseudo-random bit sequence or the like. BERT element 142 correlates an internally generated bit sequence matching the sequence originally transmitted by optical transmitter 11 against the recovered bit sequence. Errors are then counted over the received sequence to generate the bit error rate which is supplied to controller 143.

Controller 143 is coupled to both tunable dispersion compensator 141 and BERT element 142. Controller 143 is responsive to the bit error rate measured for a given amount of dispersion introduced by tunable dispersion compensator 141 increasing or decreasing the dispersion introduced by compensator 141 so that the bit error rate is minimized. For each dispersion change induced by controller 143, the bit error rate generally changes. Controller 143 responds to the bit error rate changes with dispersion changes that are selected by the controller to reduce and even minimize the residual chromatic dispersion in the system.

In one example from experimental practice, the controller 143 steps the dispersion setting in tunable dispersion compensator 141 from its minimum setting to its maximum setting. The stepping process may be made in either coarse or fine increments. Regardless of the dispersion increment (step), a bit error rate is recorded for each dispersion setting. A minimum bit error rate or optimum bit error rate that is other than the minimum is then apparent from the recorded bit error rate measurements. Tunable dispersion compensator 141 is then set to compensate at least a portion of the residual chromatic dispersion depending on whether the controller adjusts compensator 141 to a dispersion associated with the minimum bit error rate (i.e., substantially complete or with a non-minimum bit error rate (i.e., partial compensation of the residual chromatic dispersion). If coarse increments are used in the stepping process to determine an approximate minimum bit error rate, then finer increments can be employed subsequently in the vicinity of the approximate minimum in order to locate the minimum bit error rate.

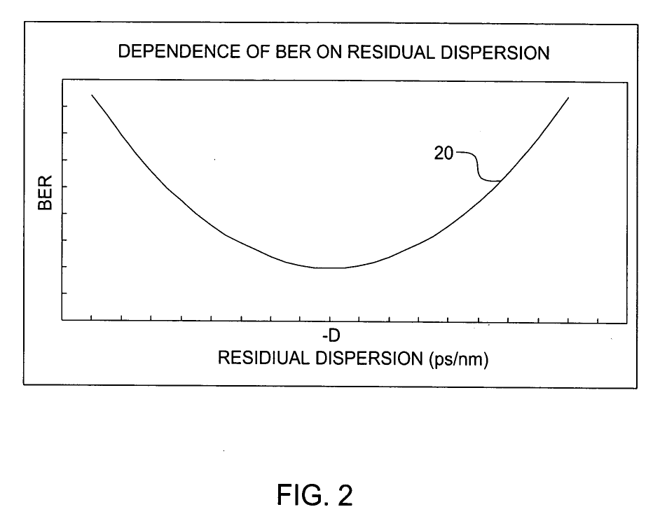

One exemplary relationship between the bit error rate and the amount of dispersion needed to compensate the residual chromatic dispersion and thereby arrive at the bit error rate is shown as curve 200 in FIG. 2. In curve 200, the minimum bit error rate occurs when the residual chromatic dispersion, D ps/nm, is compensated by −D ps/nm dispersion introduced by tunable dispersion compensator 141. It should be noted that the complement of the amount of dispersion introduced by the tunable dispersion compensator at the minimum bit error rate is the total residual chromatic dispersion in the system. For some applications, it may be desirable to compensate all or only some of the total residual chromatic dispersion in the system.

Measurement of bit error rate for a predetermined amount of chromatic dispersion introduced by the tunable dispersion compensator can be performed under conditions substantially identical to those used in actual operation of the optical transmission system. For example, the optical transmission wavelength, launch power, optical amplification settings, modulation scheme, and the like can be set to the actual operating parameters. In such a case, the minimum bit error rate will correspond to a residual amount of chromatic dispersion which, if compensated, will insure minimum bit error rate performance during system operation. If the actual operating conditions are not utilized when measuring the bit error rates for different inserted amounts of dispersion by the tunable compensator, then the minimum bit error rate found during the measurement procedure may not necessarily correspond to the residual chromatic dispersion that actual occurs when the system is made operational. That is, the residual chromatic dispersion found by the bit error rate technique may be different from the residual chromatic dispersion experienced during system operation thereby causing the bit error rate to be different.

It is understood by those persons skilled in the art that the present embodiment of the module is capable of measuring residual chromatic dispersion accumulated through the entire system or at least up to the point of module insertion. The module is not capable of identifying and measuring the individual uncompensated chromatic dispersion contributions from sections or spans of the optical transmission system. As noted above, the module could be inserted at various positions in transmission system 12 provided that the module 14 was accompanied by a receiver element for recovering the transmitted bit sequence. The preferred embodiment of the module and its location in the system is as shown in FIG. 1.

While it is possible, it is not generally expected that the residual chromatic dispersion will be compensated in such a way that the bit error rate becomes zero. This condition is not generally expected because system effects other than chromatic dispersion, such as noise generated by optical amplifiers and the like, can contribute to bit errors.

Accuracy of the residual chromatic dispersion measurement and compensation technique described herein is improved by insuring the optical signal-to-noise ratio (OSNR) at the receiver is sufficient to allow the receiver to synchronize to the received optical signal. In addition, it has been found that a substantially chirp-free transmitter improves the measurements. Measurement accuracy can also be improved by reducing signal distortions from nonlinear system effects such as those caused by launch power levels and amplifier output levels.

In a DWDM system, a wide wavelength range (e.g. 1530 nm to 1565 nm) is used for the simultaneous transmission of multiple channels at different wavelengths. As the chromatic dispersion of the transmission fiber as well as that of dispersion compensating modules varies with wavelength, a wavelength-resolved measurement of the residual chromatic dispersion may be required. The measurement system described herein may be adapted for this purpose by using a wavelength-tunable transmitter and a wideband tunable dispersion compensator (both are well known components in the art). The measurement technique is performed in the same way as described above with the additional procedure that each measurement of bit error rate versus tunable dispersion compensator setting is carried out separately for each wavelength of interest

1. A method for measuring residual chromatic dispersion in an optical transmission system, the method comprising the steps of:
introducing a predetermined amount of chromatic dispersion at the receive end of the system;
measuring a bit error rate for the system corresponding to the predetermined amount of chromatic dispersion;
iterating the introducing and measuring steps until the bit error rate is a minimum over all measured bit error rates;
wherein the residual chromatic dispersion in the optical transmission system is represented by a complement of the predetermined amount of chromatic dispersion at which the minimum bit error rate is achieved.

2. The method as defined in claim 1 wherein step of iterating is responsive to the bit error rate in the measuring step and includes selecting a new predetermined amount of chromatic dispersion for the introducing step.

3. The method as defined in claim 2 wherein the step of selecting further includes controlling selection of the predetermined amount of chromatic dispersion in a manner to produce a minimum bit error rate.

4. The method as defined in claim 1 further including the step of compensating at least some portion of the residual chromatic dispersion in the optical transmission system by selecting a compensating amount from a chromatic dispersion range including 0 ps/nm through and including the predetermined amount of chromatic dispersion at which the minimum bit error rate was achieved.

5. The method as defined in claim 4 wherein step of iterating is responsive to the bit error rate in the measuring step and includes selecting a new predetermined amount of chromatic dispersion for the introducing step.

6. The method as defined in claim 5 wherein the step of selecting further includes controlling selection of the predetermined amount of chromatic dispersion in a manner to produce a minimum bit error rate.

7. Apparatus for measuring residual chromatic dispersion in an optical transmission system, the apparatus comprising:
a dispersion compensator for introducing a predetermined amount of chromatic dispersion at the receive end of the system;
a bit error rate test element for measuring a bit error rate for the system corresponding to the predetermined amount of chromatic dispersion;
a control element coupled to said compensator and said test element for adjusting said compensator to a new predetermined amount of chromatic dispersion in order to reduce the bit error rate for the system;
wherein at least a portion of the residual chromatic dispersion in the optical transmission system is represented by a complement of the predetermined amount of chromatic dispersion at which the reduced bit error rate was achieved.

8. The apparatus as defined in claim 7 wherein the control element adjusts the compensator to a new predetermined amount of chromatic dispersion in order to minimize the bit error rate for the system, the residual chromatic dispersion in the optical transmission system being represented by a complement of the predetermined amount of chromatic dispersion at which a minimum bit error rate is achieved.

9. The apparatus as defined in claim 8 wherein the control element adjusts the dispersion compensator to a compensating amount of chromatic dispersion selected from a chromatic dispersion range including 0 ps/nm through and including the predetermined amount of chromatic dispersion at which the minimum bit error rate was achieved.
